(19) United States
(12) Patent Application Publication
(10) Pub. No.: US 2023/0056772 A1
(43) Pub. Date: Feb. 23, 2023

(54) INFLUENCE FUNCTION IN MACHINE LEARNING FOR INTERPRETATION OF LENGTHY AND NOISY DOCUMENTS

(71) Applicant: International Business Machines Corporation, Armonk, NY (US)

(72) Inventors: Yada Zhu, Irvington, NY (US); Wei Zhang, Acton, MA (US); Guangnan Ye, Scarsdale, NY (US); Xiaodong Cui, Chappaqua, NY (US)

(21) Appl. No.: 17/408,944

(22) Filed: Aug. 23, 2021

(51) Int. Cl. G06Q 30/02; G06N 3/08; G06F 40/30

(52) U.S. Cl. CPC G06Q 30/0202; G06N 3/08; G06Q 30/0201; G06F 40/30

(57) ABSTRACT

A neural network to predict a future indicator of a given entity can be trained based on historical earnings call data and historical market data. An earnings call transcript can be received, from which to predict the future indicator. Preprocessing can be performed using a natural language processing (NLP) technique to select candidate sentences from the earnings call transcript. For a candidate sentence in the candidate sentences, and using the trained neural network, a sentence gradient can be determined, which is indicative of sensitivity of the trained neural network to the candidate sentence. Based on the determined sentence gradient associated with each of the candidate sentences, an explanation of the trained neural network's predicted future indicator can be provided.

### BACKGROUND

The present application relates generally to computers and computer applications, natural language processing and machine learning in document interpretation, and more particularly to influence functions in machine learning for interpreting data.

Document interpretation such as analyzing of financial documents has gained recent attention in the natural language processing (NLP) community. Even with current advancements in the natural language processing techniques, however, certain documents can pose challenges in a computer processor's ability to automatically interpret and analyze those documents. An example is an earnings call or a transcript of such an earnings call, which tends to be lengthy (e.g., greater than 500 sentences) than other types of documents and to contain more noisy information. An earnings call is a channel for an organization to disclose its performance, and information gleaned from an earnings call can help in forecasting future performances of an organization. For instance, an automated computer processor may be able to predict a company's stock volatility based on automatically or autonomously extracting information from an earnings call of that company by using NLP-based methods. However, with longer transcripts or documents, NLP models can have difficulty in learning the semantic structure from the documents. Further, in documents such as earnings call transcripts, machine learning models may have difficulty in pinpointing the most salient sentences in the documents. Hence, an improvement in computer processing or a processor's ability to interpret such documents automatically and efficiently can be beneficial.

### BRIEF SUMMARY

The summary of the disclosure is given to aid understanding of a computer system and method of machine learning and interpreting data or documents such as earnings call, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

A system, in an aspect, can include a processor and a memory device coupled with the processor. The processor can be configured to receive historical earnings call data. The processor can also be configured to receive historical market data. The processor can also be configured to train a neural network to predict a future indicator of a given entity based on the historical earnings call data and the historical market data. The processor can also be configured to receive an earnings call transcript, from which to predict the future indicator. The processor can also be configured to preprocess the earnings call transcript using a natural language processing (NLP) technique to select candidate sentences from the earnings call transcript. The processor can also be configured to, for a candidate sentence in the candidate sentences and using the trained neural network, determine a sentence gradient indicative of sensitivity of the trained neural network to the candidate sentence. The processor can also be configured to, based on the determined sentence gradient associated with each of the candidate sentences, provide an explanation of the trained neural network's predicted future indicator.

A computer-implemented method, in an aspect, include receiving historical earnings call data. The method can also include receiving historical market data. The method can also include training a neural network to predict a future indicator of a given entity based on the historical earnings call data and the historical market data. The method can also include receiving an earnings call transcript, from which to predict the future indicator. The method can also include preprocessing the earnings call transcript using a natural language processing (NLP) technique to select candidate sentences from the earnings call transcript. The method can also include, for a candidate sentence in the candidate sentences and using the trained neural network, determining a sentence gradient indicative of sensitivity of the trained neural network to the candidate sentence. The method can also include, based on the determined sentence gradient associated with each of the candidate sentences, providing an explanation of the trained neural network's predicted future indicator.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram illustrating components in a logic flow of a method in an embodiment.

FIG. 2 is an example user interface showing machine learning prediction result and explanation in an embodiment.

FIG. 3 is another example of a user interface in an embodiment.

FIG. 4 shows an example user interface, which allows for performing an earnings call analysis in an embodiment.

FIG. 5 is a flow diagram illustrating a method of training a machine learning model to predict an outcome and providing an explanation for the outcome in an embodiment.

FIG. 6 is a diagram showing components of a system in one embodiment that performs machine learning, e.g., training a neural network and using an influence function for interpretation of the neural network's output prediction.

FIG. 7 illustrates a schematic of an example computer or processing system that may implement a system in one embodiment.

FIG. 8 illustrates a cloud computing environment in one embodiment.

FIG. 9 illustrates a set of functional abstraction layers provided by cloud computing environment in one embodiment of the present disclosure.

### DETAILED DESCRIPTION

A system and method are disclosed, which can discover important or salient sentences or phrases in documents such as earnings call transcripts, and by the explanation in the latent space, which can provide factors which contribute to predicting and affecting a machine learning model's output or prediction such as the prediction of stock volatility in the future based on an earnings call transcript. In an embodiment, the system and method use advanced NLP-based pre-processing of sentence selections as well as Influence Function (IF) and/or TracIn, in analyzing the sentence importance in a document such as an earnings call transcript.

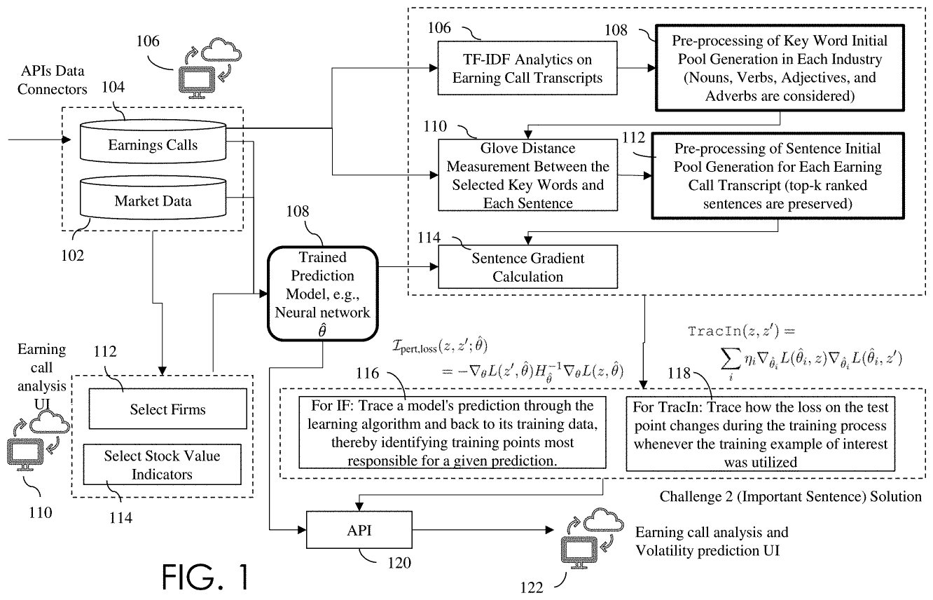

FIG. 1 is a diagram illustrating components in a logic flow of a method in an embodiment. The method using an NLP technique automatically interprets an earnings call document or transcript and determines important or salient sentences in the earnings call, for example, which can be used in machine learning to predict future performance of an organization. For instance, the method can select from a document, which can be noisy and lengthy, those sentences or phrases, which signal a company's stock volatility, for which, increase or decrease in the company's stock.

The components shown include computer-implemented components, for instance, implemented and/or run on one or more hardware processors, or coupled with one or more hardware processors. One or more hardware processors, for example, may include components such as programmable logic devices, microcontrollers, memory devices, and/or other hardware components, which may be configured to perform respective tasks described in the present disclosure. Coupled memory devices may be configured to selectively store instructions executable by one or more hardware processors.

A processor may be a central processing unit (CPU), a graphics processing unit (GPU), a field programmable gate array (FPGA), an application specific integrated circuit (ASIC), another suitable processing component or device, or one or more combinations thereof. The processor may be coupled with a memory device. The memory device may include random access memory (RAM), read-only memory (ROM) or another memory device, and may store data and/or processor instructions for implementing various functionalities associated with the methods and/or systems described herein. The processor may execute computer instructions stored in the memory or received from another computer device or medium.

Data can be received for processing via one or more application programming interfaces and/or data connectors and stored on one or more storage devices. For example, one or more computer processors 106 can receive market data 102 and earnings call data or transcripts 104 from one or more data sources over a network, for example, using one or more application programming interface (API) data connectors. Market data 102 can include data such as stock prices, earnings such as quarterly or periodic earnings, stock volatility, and/or other like financial indicators. Earning call transcripts 104 include audio (e.g., speech) or text transcripts of what was presented during earnings calls. Audio data can be converted to text transcripts using a speech-to-text conversion technique. One or more computer processors 106 may store the data 102, 104 on one or more storage devices.

Using at least some of the market data 102 and the earnings call data 104 as ground truth data for training, a computer processor may train a prediction model such as a neural network 108 to learn to predict a future performance of a given company or organization. For example, the trained model 108 can predict future financial performance such as stock volatility, given an earnings call data or transcript. Market data 102 and earnings call data 104 can be stored on a storage device and/or one or more computer processors 106 can receive such data from one or more data sources over a network, for example, using one or more application programming interface (API) data connectors.

In an embodiment, by way of example, a processor may train a neural network 108 such as a BERT (Bidirectional Encoder Representations from Transformers) model. Briefly BERT (Bidirectional Encoder Representations from Transformers) is a machine learning language model for natural language processing (NLP). The neural network 108, e.g., a BERT model, can learn language context of the earnings call data 104 and can be fine-tuned with a classification layer to predict a stock price or another financial indicator based on the language context of the earnings call data and the market data 102. For example, market data 102 and earnings call data 104 are used as ground truth data for correlating stock price with information from an earnings call transcript in training the neural network 108. Such data can pertain to a particular entity whose stock price or like financial performance is being predicted.

In an embodiment, the particular entity or company for which a prediction is to be performed can be input by a user and received by a processor, for example, via a user interface 110 as shown at 112. Via the user interface 110, the processor may also receive user input or user specified indictors to predict as shown at 114.

In an embodiment, a processor also preprocesses an earnings call transcript 104 to select or generate sentence candidates in the lengthy earnings call transcripts, for example, shown at 116, 118, 120 and 122. Such preprocessing can provide a solution to analyzing or interpreting a long or lengthy document. For example, at 116, a processor may perform a TF-IDF analytics on the earnings call transcripts 104. Performing the term frequency-inverse document frequency (TF-IDF) analytics selects or extracts keywords from the earnings call transcripts 104. The TF-IDF processed keywords are those considered to be important in a given industry. In an embodiment, such keywords are extracted for each of different industries. The TF-IDF processing generates an initial pool of keywords, for example, for each industry. In an embodiment, nouns, verbs, adjectives, and adverbs can be considered, which are used in a particular industry. Briefly, TF-IDF is a technique that reflects how important a word is to a document in a corpus of documents.

At 110, distance measurement between the selected or extracted keywords and each sentence in the earnings call transcript is determined. For example, a glove distance measurement can be performed. The glove distance measurement measures the distance between each keyword and words in each sentence in an earnings call transcript. This measurement can determine which words in the sentence are close to the extracted keywords. The sentences can be ranked based on the proximity of the words contained in a sentence to the TF-IDF extracted keywords. As shown at 112, preprocessing by a processor can include generating an initial pool of sentences. This initial pool of sentences can include top k-ranked sentences, where k is a configurable or predefined number. For instance, top k-ranked sentences can be preserved for use. In this way, a solution to shortening a lengthy document can be provided.

At 114, sentence gradient calculation is performed using the initial pool of sentences and the trained prediction model trained at 108. Sentence gradient calculation uses selected sentences to train an existing machine learning model, e.g., neural network, 108 and calculates intermediate results associated with the neural network or machine learning model's prediction. For instance, sentence gradient can be calculated in several ways. In an embodiment, a processing at 116 calculates sentence gradient. In another embodiment, a processing at 118 can calculate sentence gradient. A sentence gradient can indicate or tell which sentence is important for training the neural network or machine learning model 108.

A sentence gradient measures sensitivity of a sentence in the input text (e.g., earnings call transcript used as input to the machine learning model to train the model) to the metric being predicted, for example, stock volatility. Consider an input text (earnings call transcript) with 100 sentences. The sentences in the initial pool generated at 112 can be selected to determine, which of those sentences are most sensitive to the output (predicted metric) of the neural network or machine learning model 108. For example, a calculated sentence gradient can be considered as a measurement of sensitivity. For example, if using a sentence causes a change in the predicted output metric, then the sentence is considered as being sensitive toward this metric compared to others. As another example, consider that an input to the neural network is an earnings call transcript with 100 sentences and the output of the neural network is the sentiment of the earnings call transcript, e.g., positive or negative. Consider also that the neural network made a prediction that the overall sentiment of this earnings call transcript is positive. Gradient calculation can determine which sentences contributed to this outcome, i.e., positive sentiment. For example, gradient calculation provides weights associated with the input sentences, the weights representing the sensitivity of the machine learning model's output to the sentences having those weights.

To determine important or salient sentences in the earnings call transcript, one or more of the processing at 116 and 118 can be performed. In an embodiment, at 116, influence function (IF) is performed to trace a model's prediction through the learning algorithm and back to its training data, thereby identifying training points most responsible for a given prediction. IF can determine which training data is most responsible for the resulting prediction, which sentences in the training samples is contributing to the resulting prediction of the machine learning model.

The following is an example gradient calculation using the IF.

I_{pert,loss}(z,z′;\hat{θ})=×∇_{θ}L(z′,\hat{θ})H_{\hat{θ}}⁻¹∇_{θ}L(z,\hat{θ})

where z represents input text, z′ represents output metric, θ represents the neural network or machine learning model. The influence function (IF) assumes the influence of z can be measured by perturbing the loss function L with a fraction of the loss on z. Here H denotes the inverse-Hessian matrix calculated on the entire training dataset, ∇ denotes a gradient function. \hat{θ} represents an empirical risk minimizer, where

$$\hat{θ} {=}^{def} arg {min}_{θ ∈ Θ} \frac{1}{n} {\sum }_{i = 1}^{n} L ( {𝓏}_{i} , θ ) .$$

In an embodiment, at 118, TracIn can be performed to trace how the loss on the sample data (e.g., test sample or test point) changes during the training process whenever the training example of interest was utilized. Performing TracIn can determine which sentence in the training or testing are important in machine learning training and testing procedures.

The following is an example gradient calculation using the TracIn.

$$TracIn ( z , {z}^{′} ) = {\sum }_{i} {η}_{i} {∇}_{{\hat{θ}}_{i}} L ( {\hat{θ}}_{i} , z ) {∇}_{{\hat{θ}}_{i}} L ( {\hat{θ}}_{i} , {z}^{′} )$$

where z represents input text, z′ represents output metric, θ represents the neural network or machine learning model. L is a loss function, ∇ denotes a gradient function. \hat{θ} represents an empirical risk minimizer, where

$$\hat{θ} {=}^{def} arg {min}_{θ ∈ Θ} \frac{1}{n} {\sum }_{i = 1}^{n} L ( {𝓏}_{i} , θ ) .$$

In an embodiment, TracIn assumes the influence of a training instance z is the sum of its contribution to the overall loss all through the entire training history. “i” iterates the checkpoints saved at different training steps and ηᵢ is a weight specific to each checkpoint. For example, for a particular training example z, the system and/or method can approximate the idealized influence by summing up this approximation in the iterations (e.g., all the iterations) in which z was used to update the parameters. In an embodiment, to measure the influence of z on z′, the system and/or method can measure the similarity of gradient (e.g., which may represent sensitivity) of z (∇_{\hat{θ}}_{ᵢ}L(\hat{θ}ᵢ, z)) and z′(∇_{\hat{θ}}_{ᵢ}L(\hat{θ}ᵢ, z′)) given the loss function L. In an embodiment, this can be done by the inner product of the two gradient vectors. The overall influence can be a sum of the similarity over all the iterations with a weight on each iteration.

Either one or both of IF at 116 and TracIn at 118, can be performed to determine the important or salient sentence or sentences. IF and TracIn can provide for machine learning explainability, e.g., explain how the machine learning model arrived at its output.

An application programming interface (API) 120 may communicate the determined result or data to a user interface 122, for example, a graphical user interface (GUI). The user interface 122 can be the same user interface at 110, or a different user interface. The user interface 122 presents the resulting prediction, and also an explanation of how the prediction was determined by showing the important or salient sentences in the earnings call transcript, which contributed to the resulting prediction, for example, a supporting evidence or factor. The sentences that will affect the prediction can also be shown.

By way of example, an experimental dataset can contain 16,167 earnings call transcripts with 1022 different companies categorized into 12 industries. Each earnings call transcript contains the opening remark part (OP) and the question and answer part (QA). From the collected earnings call transcripts, TF-IDF words or keywords in the “healthcare” industry can be determined, e.g., “revenue”, “patient”, “growth”, “medicine”, “product”, “guidance”, and others. Selected sentences from an earnings call transcript, based on performing a distance measurement between the keywords and the words in the sentences contained in the earnings call can be: “With our diverse commercial portfolio, growing revenues and multiple programs that provide significant opportunities in a range of cancer types, we are well-positioned for the future” (Sentiment: Positive); and “The decrease in collaboration revenues is the result of a $30 million milestone from Company_T earned last year that was triggered by the approval of Medicine_A in Region_Z for frontline Hodgkin lymphoma” (Sentiment: Positive).

In an embodiment, using IF and TracIn techniques, a processor can automatically compute sentence selection, and summarize earnings call transcripts, with machine learning predictions and explanation for the predictions.

The system and method disclosed herein can discover important or salient sentences in earnings calls and by an explanation in a latent space, provide certain factors which will predict and affect value metrics such as the stock volatility in the future. The system and method in an embodiment uses NLP-based pre-processing of sentence selections, Influence Function (IF) and/or TracIn techniques. An NLP pre-processing method disclosed herein can generate sentence candidates in lengthy documents such as long earning call transcripts. The method can also use IF and/or TracIn to analyze the sentence importance in each earnings call transcripts, which can also be a factor in predicting a value metric such as stock volatility.

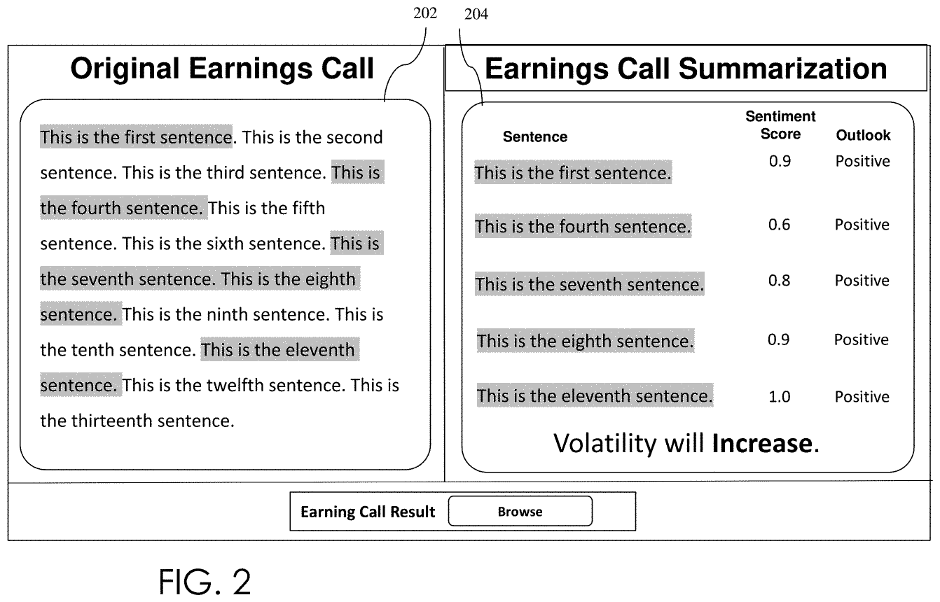

FIG. 2 is an example user interface showing machine learning prediction result and explanation in an embodiment. By way of example, an original earnings call content 202 can be shown in a window or frame. Another window or frame can show a summarization 204. The summarization 204, for example, can show sentences (e.g., top k-ranked sentences generated during preprocessing) which were used in training, score for the sentences and the outlook or sentiment associated with the sentences. For example, sentences can be selected or identified by IF or TracIn, and a natural language processing (NLP) sentiment analytics tool may produce the sentiment score associated with the selected sentence. Each of the sentences in the summarization 204 can be highlighted or otherwise emphasized or distinguished in the original content, e.g., as shown at 202. In this example, the value metrics is stock volatility. For example, the machine learning model is trained to predict stock volatility, and predicts based on the original earnings call 202, that the stock volatility will increase. An explanation for such prediction is provided by way of listing the sentences and their scores and outlook as shown at 204.

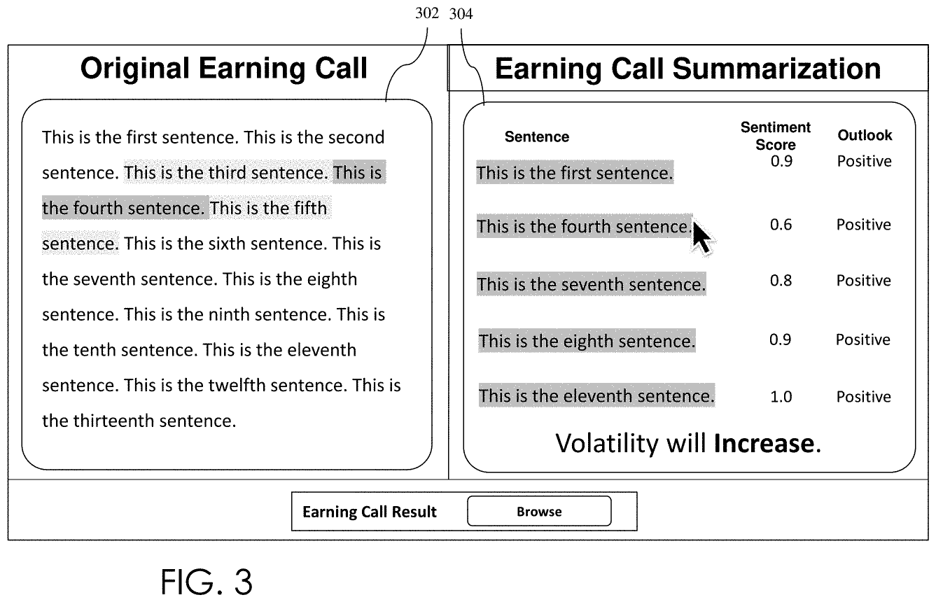

FIG. 3 is another example of a user interface in an embodiment. In this figure, a user clicking on or selecting a sentence in a summarization window 304, also highlights (or otherwise emphasizes or distinguishes) the surrounding sentences in the original content window 302. For instance, if “This is the fourth sentence” is selected in the summarization window 304, “This is the third sentence” and “This is the fifth sentence”, which surround the selected sentence are highlighted in the original content window 302.

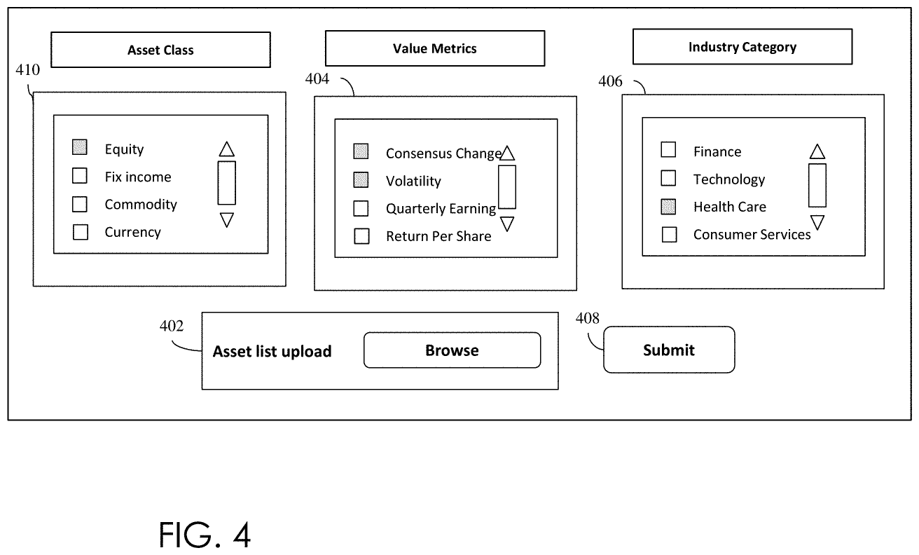

FIG. 4 shows an example user interface, which allows for performing an earnings call analysis in an embodiment. The user interface or a graphical user interface can provide graphical elements or features, which a user may select or click, and/or input information. For example, a menu or like graphical element can be presented for an asset class 410, allowing a user to select an asset class for consideration. Another menu or like graphical element can allow a user to input or select a value metrics 404 for a machine learning model to learn to predict. Examples of value metrics can include, but are not limited to “consensus change”, “volatility”, “quarterly earning”, and “return per share.” Yet another menu or like graphical element or feature can allow a user to input industry category 406 to consider, e.g., “finance”, “technology”, “healthcare”, and “consumer services.” A graphical element or feature can also allow a user to upload a list of assets by browsing storage folder or directories as shown at 402. At submit button 408 or like graphical element or feature allows a user to select to initiate the processing of the earnings call analysis and financial indicator prediction using machine learning and NPL techniques. Via the user interface, a user can upload a list of assets and corresponding asset value metric, and industry category to use, to summarize the earnings call important sentences.

An earning call analytics and summarization disclosed herein allows end users to select and upload asset list, select asset value metrics, and visualize the important sentences as well as the volatility prediction with the sentence evidence factors in the earnings call summarization.

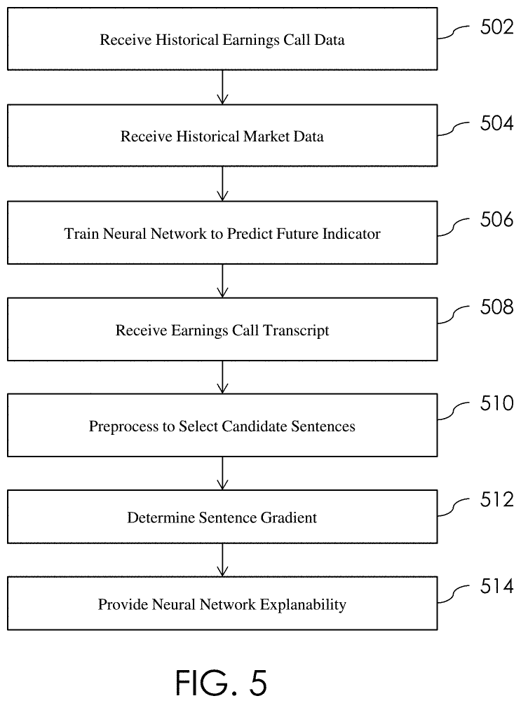

FIG. 5 is a flow diagram illustrating a method of training a machine learning model to predict an outcome and providing an explanation for the outcome in an embodiment. The method can be performed by or implemented on one or more computer processors, including a hardware processor. At 502, earnings call data, for example, collected or historical earnings call data can be received. Earning call data can include audio or text transcripts of what was presented during earnings calls. At 504, market data, for example, historical market data, can be received. Market data can include data such as stock prices, earnings such as quarterly or periodic earnings, stock volatility, and/or other like financial indicators.

At 506, a neural network can be trained to predict a future indicator of a given entity based on the historical earnings call data and the historical market data. For example, the trained neural network can predict the future indicator such as stock volatility or another performance indicator, given an earnings call data or transcript.

At 508, an earnings call transcript, from which to predict the future indicator, can be received. The earnings call transcript can include an audio or text transcript of what was presented during an earnings call of the given entity.

At 510, the earnings call transcript can be processed using a natural language processing (NLP) technique to select candidate sentences from the earnings call transcript. For example, a term frequency-inverse document frequency (TF-IDF) analytics can be performed on the historical earnings call data, where the TF-IDF analytics extracts keywords from the historical earnings call data, the keywords extracted according to an industry category associated with the given entity. For each sentence in the earnings call transcript, a distance measurement can be computed based on comparing words in the sentence with the keywords. The sentences can be ranked based on the computed distance measurement. Top k-ranked sentences can be selected as the candidate sentences, wherein k can be predefined or preconfigured or configured dynamically.

At 512, for a candidate sentence in the candidate sentences and using the trained neural network, a sentence gradient indicative of sensitivity of the trained neural network to the candidate sentence can be determined. In an embodiment, the sentence gradient can be determined by performing an influence function (IF) that measures pairwise sensitivity between the candidate sentence input to the neural network and the predicted future indicator output by the neural network. In another embodiment, the sentence gradient can be determined by tracing how a loss on a point changes during a training process of the neural network responsive to the candidate sentence being utilized as input to the neural network.

At 514, based on the determined sentence gradient associated with each of the candidate sentences, an explanation of the trained neural network's predicted future indicator can be provided. In an embodiment, such presentation can be done via a graphical user interface or a dashboard.

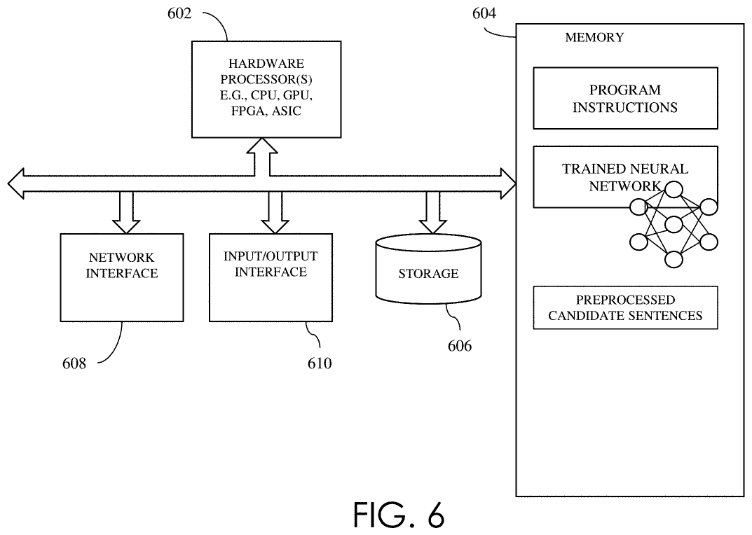

FIG. 6 is a diagram showing components of a system in one embodiment that performs machine learning, e.g., training a neural network and using an influence function for interpretation of earnings. One or more hardware processors 602 such as a central processing unit (CPU), a graphic process unit (GPU), and/or a Field Programmable Gate Array (FPGA), an application specific integrated circuit (ASIC), and/or another processor, may be coupled with a memory device 604, and generate a prediction model, e.g., train a neural network model to predict a financial indicator for a company given an earnings call data or transcript associated with that company. One or more hardware processors 602 may also generate a keyword list, e.g., using a TF-IDF technique based on an industry category of the company, and generate a list of candidate sentences to use in training the neural network model. One or more hardware processors 602 can calculate a gradient (also referred to as a sentence gradient) associated with each of the candidate sentences, for example, using the IF technique and/or the TracIN technique. Another type of IF technique can be utilized. The sentence gradient tells or indicates the importance of the candidate sentence to the neural network training, for example, the neural network outcome's sensitivity to the candidate sentence. A memory device 604 may include random access memory (RAM), read-only memory (ROM) or another memory device, and may store data and/or processor instructions for implementing various functionalities associated with the methods and/or systems described herein. One or more processors 602 may execute computer instructions stored in memory 604 or received from another computer device or medium. A memory device 604 may, for example, store instructions and/or data for functioning of one or more hardware processors 602, and may include an operating system and other program of instructions and/or data. One or more hardware processors 602 may receive input including earnings call and market data. Such input data may be stored in a storage device 606 or received via a network interface 608 from a remote device, and may be temporarily loaded into a memory device 604 for building or generating the prediction model (e.g., the neural network) and/or other processing performed by one or more processors 602. The trained neural network may be stored on a memory device 604, for example, for running by one or more hardware processors 602. One or more hardware processors 602 may be coupled with interface devices such as a network interface 608 for communicating with remote systems, for example, via a network, and an input/output interface 610 for communicating with input and/or output devices such as a keyboard, mouse, display, and/or others.

While the examples disclosed herein referred to interpreting earnings calls and predicting financial indicators, the system and/or method can apply to interpreting other types of documents and machine learning predicting or classifying other types of outputs or indicators.

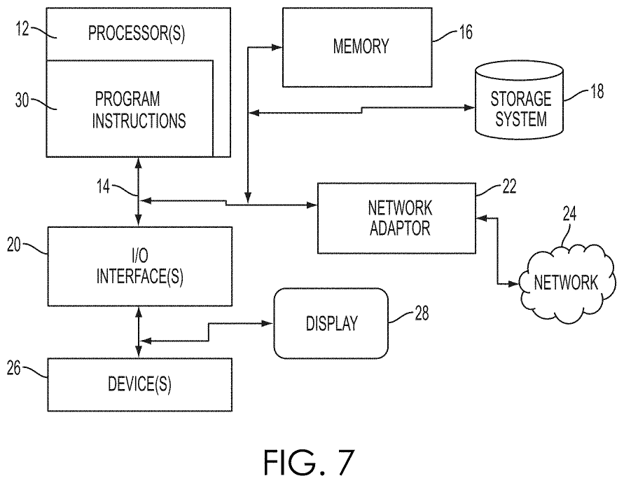

FIG. 7 illustrates a schematic of an example computer or processing system that may implement a system in one embodiment. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 7 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being run by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

It is understood in advance that although this disclosure may include a description on cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

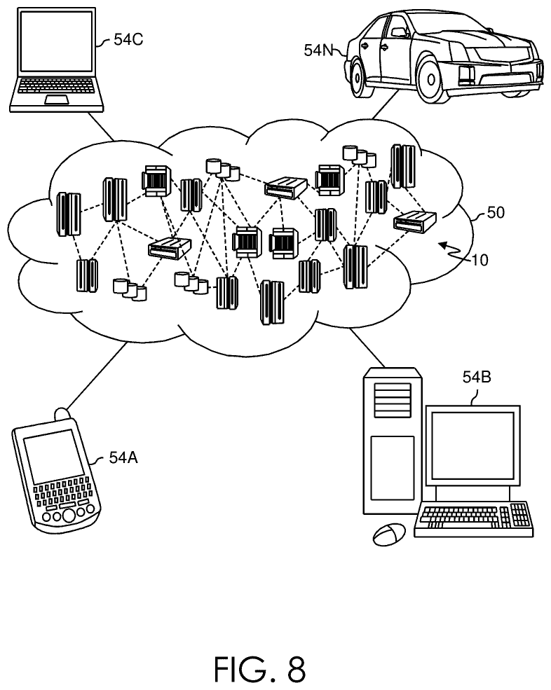

Referring now to FIG. 8, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

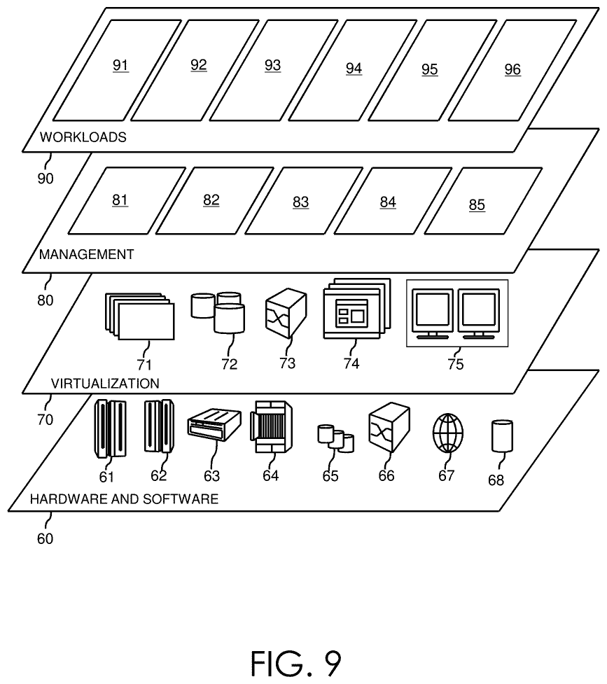

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and machine learning and earnings call analytics processing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, run concurrently, substantially concurrently, in a partially or wholly temporally overlapping manner, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in an embodiment” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
receiving historical earnings call data;
receiving historical market data;
training a neural network to predict a future indicator of a given entity based on the historical earnings call data and the historical market data;
receiving an earnings call transcript, from which to predict the future indicator;
preprocessing the earnings call transcript using a natural language processing (NLP) technique to select candidate sentences from the earnings call transcript;
for a candidate sentence in the candidate sentences and using the trained neural network,
determining a sentence gradient indicative of sensitivity of the trained neural network to the candidate sentence; and
based on the determined sentence gradient associated with each of the candidate sentences, providing an explanation of the trained neural network's predicted future indicator.

2. The method of claim 1, wherein the preprocessing the earnings call transcript using a natural language processing (NLP) technique to select candidate sentences from the earnings call transcript, includes:
performing a term frequency-inverse document frequency (TF-IDF) analytics on the historical earnings call data, the TF-IDF analytics extracting keywords from the historical earnings call data, the keywords extracted according to an industry category associated with the given entity;
for each sentence in the earnings call transcript,
computing a distance measurement based on comparing words in the sentence with the keywords, and ranking the sentences based on the computed distance measurement; and
selecting as the candidate sentences, top k-ranked sentences, wherein k is predefined.

3. The method of claim 1, wherein the determining a sentence gradient includes performing an influence function (IF) that measures pairwise sensitivity between the candidate sentence input to the neural network and the predicted future indicator output by the neural network.

4. The method of claim 1, wherein the determining a sentence gradient includes tracing how a loss on a point changes during a training process of the neural network responsive to the candidate sentence being utilized.

5. The method of claim 1, further including causing the candidate sentences to be presented on a graphical user interface.

6. The method of claim 5, further including causing the earnings call transcript to be presented with the candidate sentences highlighted on the graphical user interface.

7. The method of claim 6, further including causing the graphical user interface to allow a user to select a candidate sentence from the presented candidate sentences and to further highlight sentences appearing before and after the selected candidate sentence.

8. The method of claim 1, wherein the entity and the future indicator to predict are input by a user.

9. The method of claim 1, wherein the candidate sentences form a summarization of the earnings call transcript.

10. A system comprising:
a processor;
a memory device coupled with the processor;
the processor configured to at least:
receive historical earnings call data;
receive historical market data;
train a neural network to predict a future indicator of a given entity based on the historical earnings call data and the historical market data;
receive an earnings call transcript, from which to predict the future indicator;
preprocess the earnings call transcript using a natural language processing (NLP) technique to select candidate sentences from the earnings call transcript;
for a candidate sentence in the candidate sentences and using the trained neural network, determine a sentence gradient indicative of sensitivity of the trained neural network to the candidate sentence; and
based on the determined sentence gradient associated with each of the candidate sentences, provide an explanation of the trained neural network's predicted future indicator.

11. The system of claim 10, wherein in preprocessing the earnings call transcript using a natural language processing (NLP) technique to select candidate sentences from the earnings call transcript, the processor is configured to:
perform a term frequency-inverse document frequency (TF-IDF) analytics on the historical earnings call data, the TF-IDF analytics extracting keywords from the historical earnings call data, the keywords extracted according to an industry category associated with the given entity;
for each sentence in the earnings call transcript,
compute a distance measurement based on comparing words in the sentence with the keywords, and rank the sentences based on the computed distance measurement; and
select as the candidate sentences, top k-ranked sentences, wherein k is predefined.

12. The system of claim 10, wherein the determining a sentence gradient includes performing an influence function (IF) that measures pairwise sensitivity between the candidate sentence input to the neural network and the predicted future indicator output by the neural network.

13. The system of claim 10, wherein the determining a sentence gradient includes tracing how a loss on a point changes during a training process of the neural network responsive to the candidate sentence being utilized.

14. The system of claim 10, wherein the processor is further configured to cause the candidate sentences to be presented on a graphical user interface with associated importance scores based on the sentence gradient.

15. The system of claim 14, wherein the processor is further configured to cause the earnings call transcript to be presented with the candidate sentences highlighted on the graphical user interface.

16. The system of claim 15, wherein the processor is further configured to cause the graphical user interface to allow a user to select a candidate sentence from the presented candidate sentences and to highlight sentences appearing before and after the selected candidate sentence on the presented earnings call transcript.

17. A computer program product comprising a computer readable storage medium having program instructions embodied therewith, the program instructions readable by a device to cause the device to:
receive historical earnings call data;
receive historical market data;
train a neural network to predict a future indicator of a given entity based on the historical earnings call data and the historical market data;
receive an earnings call transcript, from which to predict the future indicator;
preprocess the earnings call transcript using a natural language processing (NLP) technique to select candidate sentences from the earnings call transcript;
for a candidate sentence in the candidate sentences and using the trained neural network,
determine a sentence gradient indicative of sensitivity of the trained neural network to the candidate sentence; and
based on the determined sentence gradient associated with each of the candidate sentences, provide an explanation of the trained neural network's predicted future indicator.

18. The computer program product of claim 17, wherein in preprocessing the earnings call transcript using a natural language processing (NLP) technique to select candidate sentences from the earnings call transcript, the device is further caused to:
perform a term frequency-inverse document frequency (TF-IDF) analytics on the historical earnings call data, the TF-IDF analytics extracting keywords from the historical earnings call data, the keywords extracted according to an industry category associated with the given entity;
for each sentence in the earnings call transcript,
compute a distance measurement based on comparing words in the sentence with the keywords, and ranking the sentences based on the computed distance measurement; and
select as the candidate sentences, top k-ranked sentences, wherein k is predefined.

19. The computer program product of claim 17, wherein the determining a sentence gradient includes performing an influence function (IF) that measures pairwise sensitivity between the candidate sentence input to the neural network and the predicted future indicator output by the neural network.

20. The computer program product of claim 17, wherein the determining a sentence gradient includes tracing how a loss on a point changes during a training process of the neural network responsive to the candidate sentence being utilized.
